(19) United States
(12) Patent Application Publication
(10) Pub. No.: US 2024/0123603 A1
(43) Pub. Date: Apr. 18, 2024

(54) TOOL CADDY FOR PLATFORM LIFT

(71) Applicant: Nicholas BRYANT, Shelbyville, IN (US)

(72) Inventor: Nicholas BRYANT, Shelbyville, IN (US)

(21) Appl. No.: 18/367,255

(22) Filed: Sep. 12, 2023

Related U.S. Application Data
(60) Provisional application No. 63/405,971, filed on Sep. 13, 2022.

(51) Int. Cl. B25H 3/06

(52) U.S. Cl. CPC B25H 3/06

(57) ABSTRACT

Tool caddy mountable on a guard rail of a lift platform includes a caddy body having an upper surface having a plurality of apertures for holding tools and construction supplies, a lower surface comprising a channel having a front side, back side and a top side, the channel being positionable over the guard rail of the lift platform, to thereby hold the caddy on the guard rail.

This US non-provisional patent application claims priority to and the benefit of US non-provisional patent application Ser. No. 63/405,971 filed 13 Sep. 2022 the entire contents of which is specifically incorporated herein by reference.

### FIELD OF THE INVENTION

The present invention relates to the storage, use and accessibility of tools utilized by construction workers such as electricians on a platform lift.

### BACKGROUND

Workers on platform lifts need to access and use many tools and building components during a job. Often, workers leave tools and boxes of components on the floor of the lift platform. They are prone to being accidentally kicked off the platform which is dangerous to others below the platform. Also, keeping such items on the floor requires the worker to repeatedly lean over to pick up the item. This leads to back injury, especially because the platform is small and the worker cannot always position himself in an optimal position to bend over, especially if more than one worker is on the platform or is wearing a safety harness that limits mobility. Having to reach for items from a platform floor also takes time, and there is a desire to minimize the time required for any job. Also, construction items need to be organized. For example a job can be completed more efficiently if required tools and supplies are always located in a consistent place on the lift, and are accessible without having to bend over.

It is also desirable to provide a system that can easily relocated between different lift platforms, or to other locations on the same lift platform, and that does not require any hardware to attach it to the platform.

### BRIEF DESCRIPTION OF THE DRAWINGS

FIG. 1 shows representative prior art lift platforms having guard rails.

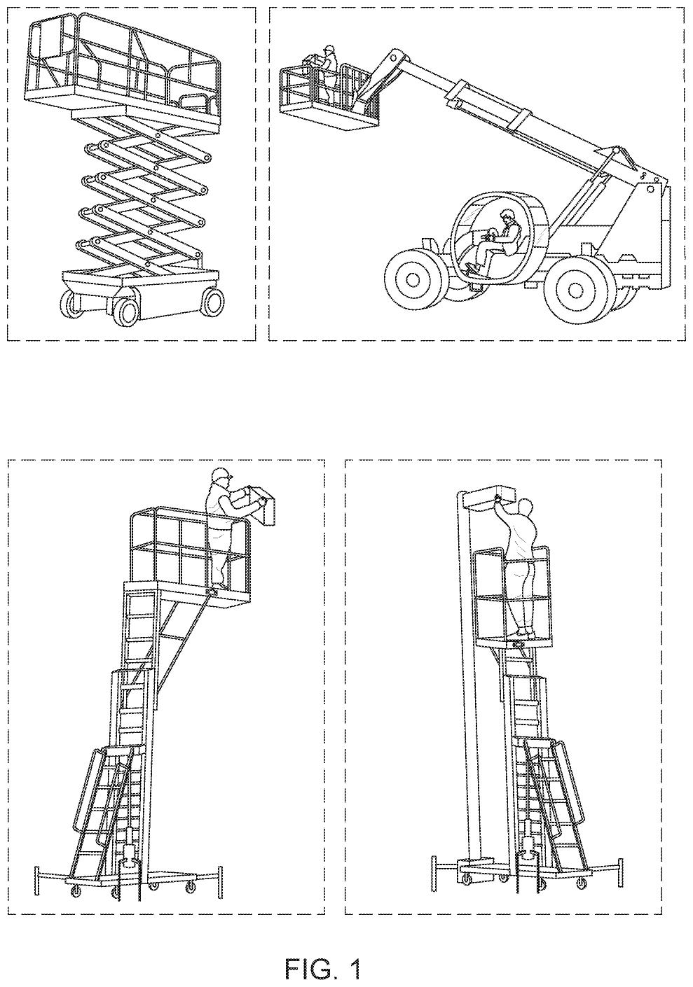

FIG. 2 shows a tool caddy having places for parts and tools mounted on a guard rail of a lift platform.

FIG. 3 shows a tool caddy of mounted on a guard rail of a lift platform with various tools and parts in the storage areas.

FIG. 4 shows a tool caddy mountable on a guard rail of a lift platform having places for various tools.

FIG. 5 shows a tool caddy mountable on a guard rail of a lift platform having places for various parts or components.

### DETAILED DESCRIPTION

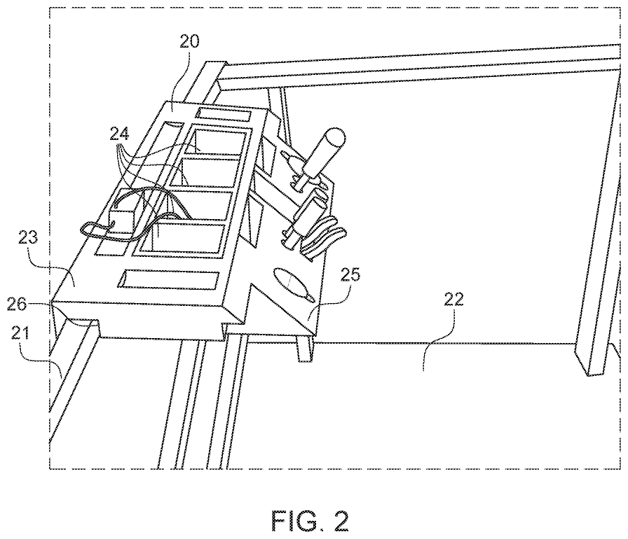

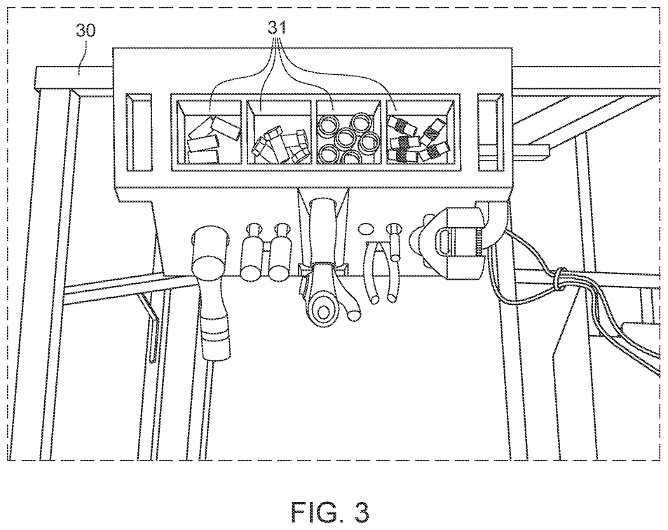

FIG. 2 shows a tool caddy 20 having places for parts and tools mounted on a guard rail 21 of a lift platform22. The caddy includes a top surface 23 having recesses 24 for storing either tools, parts, or smaller removable storage containers. It also includes an angled front surface 25 having recesses or holes for storing tools. The tool caddy does not require screws or other attachment devices to be secured to the lift platform. It has a bottom rear channel 26 that fits over guard rail 21 of the lift platform. Thus, it can easily be removed from one area on a lift platform guard rail to another area on the guard rail, or from one lift platform and moved to different lift platform. The channel allows it to be mounted on guard rails of different lift platform manufacturers. The caddy may be made of non-conductive material such as plastic, so it does not present a grounding or electrocution risk and does not mar the finished surface of the lift platform. These features are important because many contractors rent lift platforms, as opposed to owning them, so the contractors are not allowed to permanently attach tool caddies to rented lift platforms and must return them in an unblemished condition.
FIG. 3 shows a tool caddy of mounted on a guard rail of a lift platform with various tools and parts in the storage areas. A rectangular hole in the top of the caddy closest to guard rail 30 may receive square cups 31, each holding a different type of part.

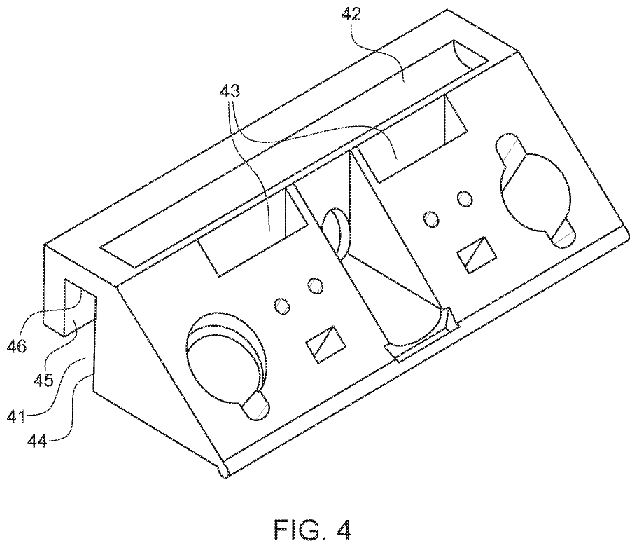

FIG. 4 shows a tool caddy mountable on a guard rail of a lift platform having places for various tools. The slots 43 at the top may hold smartphone or other devices. The rear of the caddy includes a channel 41 sized to fit over a rail of the lift platform. If the rail on the lift platform is rectangular, the rectangular channel will not rotate when the caddy is mounted thereon. This version also includes a horizontal indentation in the top of the caddy for holding parts in lieu of the cups shown in FIG. 3.

The tool caddy is reversable and may be positioned on a different rail of a lift platform, such as a lower guard rail) or so it is facing away from the platform, i.e., on the outside of the lift. This position is useful for when a worker needs to load the caddy or access tools and materials while standing on the ground and the lift is loaded. Then, a work may climb onto the lift platform, then lift, rotate, and mount the tool caddy on a guard rail so it is facing the interior of the platform as shown in FIG. 2. The caddy may be mounted on any horizontal rail, i.e., a top rail, or a middle rail. Channel 41 may have a front side 44, back side 45, and a top side 46 to thereby hold the caddy on the guard rail in a fixed position. The front 44 and back 45 sides of the channel are parallel, and top side 46 is perpendicular to the front and back sides, such that when the channel is positioned over the guard rail and the guardrail has opposing front and back sides that are parallel (as shown in FIGS. 2 and 3), the sides of the channel and the sides of the guardrail reduce pivoting of the caddy with respect to the guard rail. The tool caddy does not need to be secured to the lift platform by any attachment member that penetrates any part of the lift platform, including the guard rails. The tool caddy may also have a bottom a stop surface that prevents pivoting of the tool caddy with respect to the guard rail.

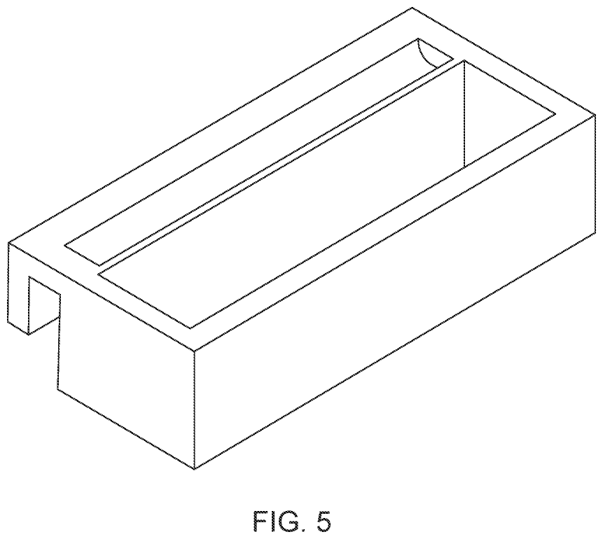

FIG. 5 shows a tool caddy mountable on a guard rail of a lift platform having places for various parts or components.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1. A tool caddy mountable on a guard rail of a lift platform comprising:
a caddy body having an upper surface having a plurality of apertures for holding tools and construction supplies,
the body having a lower surface comprising
a channel having a front side, back side, and a top side,
the channel being positionable over the guard rail of the lift platform, to thereby hold the caddy on the guard rail in a fixed position.

2. The tool caddy of claim 1 wherein:
the front and back sides of the channel are parallel, and the top side is perpendicular to the front and back sides, such that when the channel is positioned over the guard rail and the guardrail has opposing front and back sides that are parallel, the sides of the channel and the sides of the guardrail reduce pivoting of the caddy with respect to the guard rail.

3. The tool caddy of claim 2 wherein the tool caddy is not secured to the lift platform by any attachment member that penetrates any part of the lift platform, including the guard rails.

4. The tool caddy of claim 1 wherein the tool caddy is comprised of a non-conductive material.

5. The tool caddy of claim 4 wherein the tool caddy is comprised of plastic.

6. The tool caddy of claim 1 wherein the bottom surface comprises a stop surface that prevents pivoting of the tool caddy with respect to the guard rail.

7. The tool caddy of claim 1 further comprising a plurality of removal compartments that fit within one of the plurality of apertures for holding tools and construction supplies.
